(19) United States
(12) Patent Application Publication
(10) Pub. No.: US 2005/0288973 A1
(43) Pub. Date: Dec. 29, 2005

(54) System and method for changing a travel itinerary

(76) Inventors: Steven F. Taylor, Dallas, TX (US); Kevin M. Krone, Coppell, TX (US); Victor A. Lucas JR., Arlington, TX (US); Jason A. Chancellor, Coppell, TX (US); Michael S. Neely, Dallas, TX (US); Mark A. Gerber, Coppell, TX (US); Bobby D. Cude, Coppell, TX (US)

Correspondence Address: FISH & RICHARDSON P.C., P.O. BOX 1022, MINNEAPOLIS, MN, 55440-1022, US

(21) Appl. No.: 10/875,524

(22) Filed: Jun. 24, 2004

(51) Int. Cl. G06Q 10/00

(52) U.S. Cl. 705/5

(57) ABSTRACT

A system and method for changing a travel itinerary include receiving a request to make a change to a first travel itinerary that includes at least one segment, displaying an identification of one or more alternative segments, receiving a user selection of one of the alternative segments, modifying the first itinerary to include a reservation for the selected alternative segment, and releasing the segment of the first itinerary to be replaced by the selected alternative segments. The system and method may also include calculating a fare difference between the one or more alternative segments and the original segment to be replaced.

### TECHNICAL FIELD

This description relates to travel itineraries, and more particularly to changing a travel itinerary.

### BACKGROUND

Travel-related Web sites provide customers with information regarding booking flights, trains, rental cars, and other travel services to increase convenience and flexibility associated with travel planning. Often the Web site provides the price of travel, both before and after any applicable taxes and/or airport fees, and allows the customer to reserve seats on available flights, trains, boats, and rental cars at travel destinations, or even entire vacation packages. In the airline industry, for example, customers can typically go to any airline's Web site or to a general travel Web site, such as Expedia.com or Travelocity.com, to search for, and reserve, airline tickets or other travel arrangements. However, despite allowing the customer to make a reservation, most of the current travel-related Web sites do not allow the customer to make changes to the reservation in an efficient manner.

### SUMMARY

The present application recognizes that some sites only permit the reservation to be changed by forcing the customer to release the reservation and/or make an additional reservation. For example, after a customer has paid for a reservation, many sites require the customer to release the paid reservation prior to selecting a new reservation and then proceed through a complicated system to have the funds originally attributed to the erstwhile-released reservation to the new reservation.

In one general aspect, a request to make a change to an original travel itinerary that includes at least one segment is received, an identification of one or more alternative segments is displayed, and a user selection of one of the alternative segments is received. The original itinerary is modified to include a reservation for the selected alternative segment, and the segment of the original itinerary to be replaced by the selected alternative segments is released.

Implementations can include one or more of the following features. The method may include receiving an identification of the segment to be replaced from the original itinerary. The method may also include receiving an identification of the original travel itinerary and displaying the original itinerary to allow a user to select the segment to be replaced. Additionally, the method may require identity verification of the user prior to modifying the original itinerary. The alternative segments may be displayed based on receipt of a user selection of origination, destination, travel date, and/or travel time. The original itinerary may be for round-trip travel or for other travel. The method may also include calculating a fare associated with an alternative segment prior to modifying the original itinerary. The calculation of the associated fare of the alternative segment may include calculating the fare of each of the displayed alternative segments and displaying the fare difference, if any, between the alternative segment and the original segment to be replaced. Implementations of the invention may include a method, a computer product, computer software stored on a machine-readable medium, or any other suitable system.

The details of one or more implementations are set forth in the accompanying drawings and the description below. Other features will be apparent from the description and drawings, and from the claims.

### DESCRIPTION OF DRAWINGS

FIG. 1 is a flow diagram of a process for changing an itinerary.

FIG. 2 is a flow diagram of a process for changing an itinerary that includes a fare change.

FIG. 3 is a block diagram of a logic system for changing an itinerary.

FIG. 4 is an illustrative example of a user interface for entering itinerary identification parameters.

FIG. 5 is an illustrative example of a user interface for selecting one or more segments of an original itinerary to change.

FIG. 6 is an illustrative example of a user interface for entering parameters for alternative segments.

FIGS. 7A and 7B are illustrative examples of user interfaces that display segment alternatives based on parameters entered by a user.

Like reference symbols in the various drawings indicate like elements.

### DETAILED DESCRIPTION

Techniques can be implemented for allowing a user of a travel-related Web site to change an existing travel reservation. The method and system allow a user or a customer of travel services to directly change a reservation over a communications network prior to relinquishing any prior reservations or portions thereof. By allowing changes to existing reservations without forcing the customer to relinquish the existing reservation, implementations of the present invention allow the customer to change one or more segments of the itinerary after one or more segments has been completed. Additionally, last minute changes of plans will not preclude the passenger from changing an entire reservation when fewer than all segments must be changed. For the purposes of the application, the terms “customer”, “traveler”, and “user” may be used interchangeably and refer to an individual or group that participates in the processes or systems disclosed below of purchasing or obtaining travel arrangements and then making changes to the original itinerary. The term “provider” or “seller” refers to any individual, group, partnership, corporation, company, agency, or other entity that provides travel services.

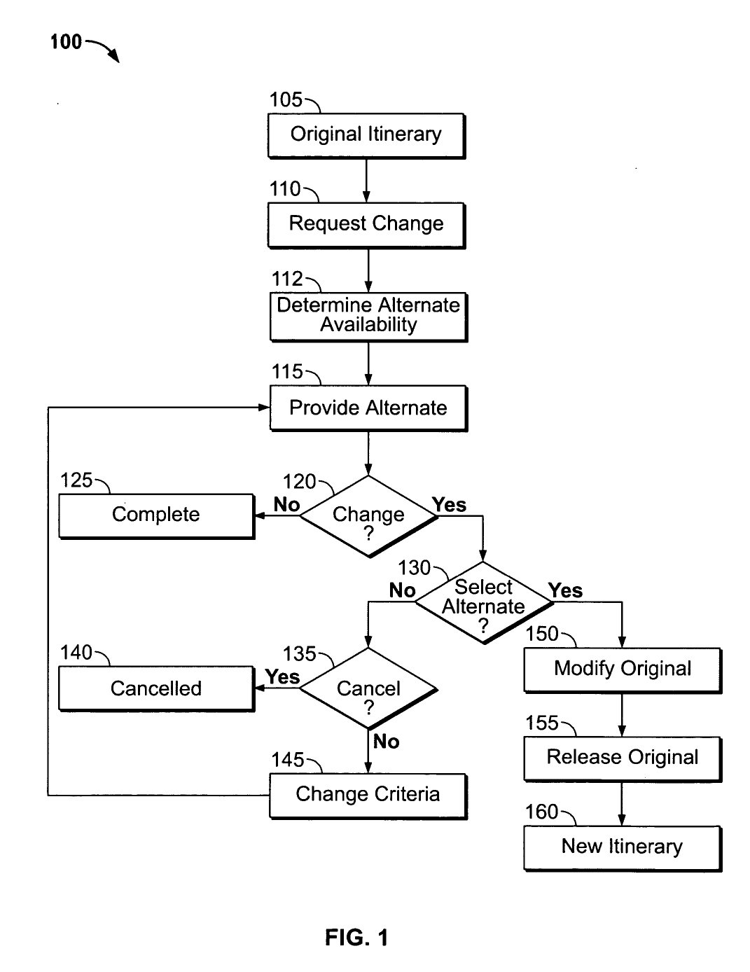

FIG. 1 is a flow diagram of a process 100 for changing a travel itinerary. The process 100 includes having an original itinerary in place (step 105). The original itinerary may be a reservation that has been purchased or merely reserved with a transportation provider. Additionally, the itinerary may involve rental cars, rail travel, air travel, car service, or any other type of travel itinerary. The original itinerary may be subject to fare rules that are associated with a fare class. For example, regardless of the type of travel, certain criteria may be required to be met for a fare that is priced according to the rules of the fare class. For example, a fare rule for a particular fare class may allow both the departure and return segments of a round trip in which a round trip to be purchased at a discount compared to purchasing or reserving each segment as a one-way segment. Additionally or alternatively, a fare rule may apply a discount to an original itinerary if the time frame of the travel includes an overnight stay over a particular night of the week, such as Sunday night or Saturday night.

The fare rules and fare classes described above are merely illustrative examples, and, depending on the provider, the fare rules and/or fare classes may be based on any number of criteria. Various providers may provide fare rules and/or fare classes based on any suitable criteria for managing the sale or reservation of travel itineraries. For example, if the provider is an airline that allows a customer to select a specific seat or seat type, such as an aisle seat or window seat, or if the seat is in a particular portion of the aircraft cabin, such as business class, emergency exit row, economy class, a preferred section of economy class, or first class, a specific fare may be available for a specific class of service only under certain conditions and/or at certain times. Though a provider may offer multiple types of fare classes—even multiple fare classes in a single itinerary—an alternative travel segment may have different associated fare rules.

Typically, a passenger name record (“PNR”) is assigned to the original reservation when the reservation is issued to the customer. When the customer desires to change the itinerary, the customer may enter the PNR to retrieve the original reservation for manipulation. Once the customer has accessed the original reservation at step 105, the customer may request a change to the reservation (step 110). The change may be requested by selecting a link on a Web page or by any other suitable method of transmitting the request over a network.

After the customer requests the change at step 110, the provider may determine whether alternative travel accommodations are available (step 112). In determining whether alternative travel accommodations are available, the provider may compare the fare class and/or fare rules associated with a possible alternative segment with the fare class and/or fare rules of one or more segments of the original itinerary. Examples of suitable criteria include, but are not limited to seat availability, fare class compatibility, fare rule compatibility, and/or combinability of the segments.

“Seat availability” may be described as an available seat on a vehicle for the alternative segment of travel. Fare class compatibility may be described as the specific fare class, such as non-refundable, refundable anytime, restricted, discount, advance purchase, or other suitable fare class, being compatible or combinable with only like fare classes, or with fare classes that are defined as compatible by a fare rule associated with the fare class. For example, a “discount” fare may have an associated fare rule that requires the segment to be used with a return segment that combines the two segments as a round-trip travel reservation. Alternatively, a “refundable anytime” fare may have associated fare rules that allow it to be combined with any other fare class. Accordingly, numerous compatibility requirements may be based on fare classes.

In addition to fare classes, fare rules may apply to travel segments that are purchased as part of a travel itinerary. For example, a reservation may include a segment in a fare class, such as “advance purchase”, that requires that specific rules be followed for the customer to purchase and/or reserve the fare. For example, the fare class “advance purchase” may have one or more associated fare rules that require the segment to be reserved and/or purchased a specific number of days in advance of the segment's date. If, by way of example, the advance purchase requires the customer to reserve and/or purchase the segment 7 days in advance, the fare rule may prohibit changing the travel segment from the original itinerary to include a segment from the “advance purchase” fare class within 7 days of the travel date.

In addition to seat availability, fare class, and fare rules, combinability may also be a criteria that a provider may use to determine appropriate alternative segments. “Combinability” may be defined as the suitable combination of one segment with another. Combinability may be based on any number of criteria, including seat availability, fare class, and fare rules, as well as other criteria, such as promotions or specific travel restrictions. For example, a promotion may allow for a one-time purchase of a round trip and prohibit the combination of the round trip with other travel arrangements on the same itinerary.

Based on any number of factors that include, for example, segment availability and/or peak versus off-peak travel times in addition to the various fare classes, fare rules, combinability and seat availability described above, the number options available to a consumer to alter existing travel reservations may be limited. For example, if a certain segment of the original itinerary can only be used with a specific fare class or fare classes, the passenger may not be able to alter the segment if no segments are available in the required fare class.

If alternative travel accommodations are available at step 112, the provider may provide the alternate travel accommodations to the customer (step 115). The alternate travel accommodations may include a change of a segment of an existing flight, a change of the type of travel used (such as air to rail, rail to air, air to automobile, etc.), a change of origination, location, destination, and/or a class of service, and/or a change of date and/or time for any portion of the customer's original reservation. The availability of the alternative travel accommodations may be based on any number of criteria. For example, an alternative air travel segment may be in a different fare class, such as refundable, whereas the air segment of the original itinerary to be replaced by the alternative segment was purchased as a non-refundable fare. In such a case, the alternative segment may not be available to the customer without the customer agreeing to pay an additional fee for the alternative segment.

After the provider gives alternative travel options, the customer makes a determination of whether to change the reservation (step 120). If at step 120, the customer decides not to change the reservation, then the process is complete (step 125). If, however, the customer decides to accept one or more of the alternatives provided at step 120, then the customer makes a determination of whether to accept the alternatives provided (step 130). If the customer decides to accept the provided alternatives at step 130, then the customer may make an additional determination of whether to cancel the request to change the reservation (step 135). If the customer decides to cancel the request to change the reservation, then the reservation change is cancelled (step 140). If the customer decides not to cancel the change to the reservation, then the customer may elect to change the criteria of the request (step 145). After the customer changes the criteria at step 145, the provider may give additional alternatives for changes to the customer's reservation by returning to step 115.

The customer may change any or all of the original criteria for determining travel alternatives at step 145. For example, the customer may desire to change a different segment of travel than the segment specified in the original request at step 110. Alternatively, the customer may desire to change the date of an existing segment that varies from the original request. Accordingly, any number of criteria may be changed from the original change request of step 110 to the criteria entered at step 145.

If the customer selects one of the alternatives provided at step 130, the customer selects the desired alternative (step 150). The provider then modifies the original reservation (step 150) and releases the original portion of the reservation that has been changed through the process (step 155). The provider then issues a new itinerary to the customer (step 160).

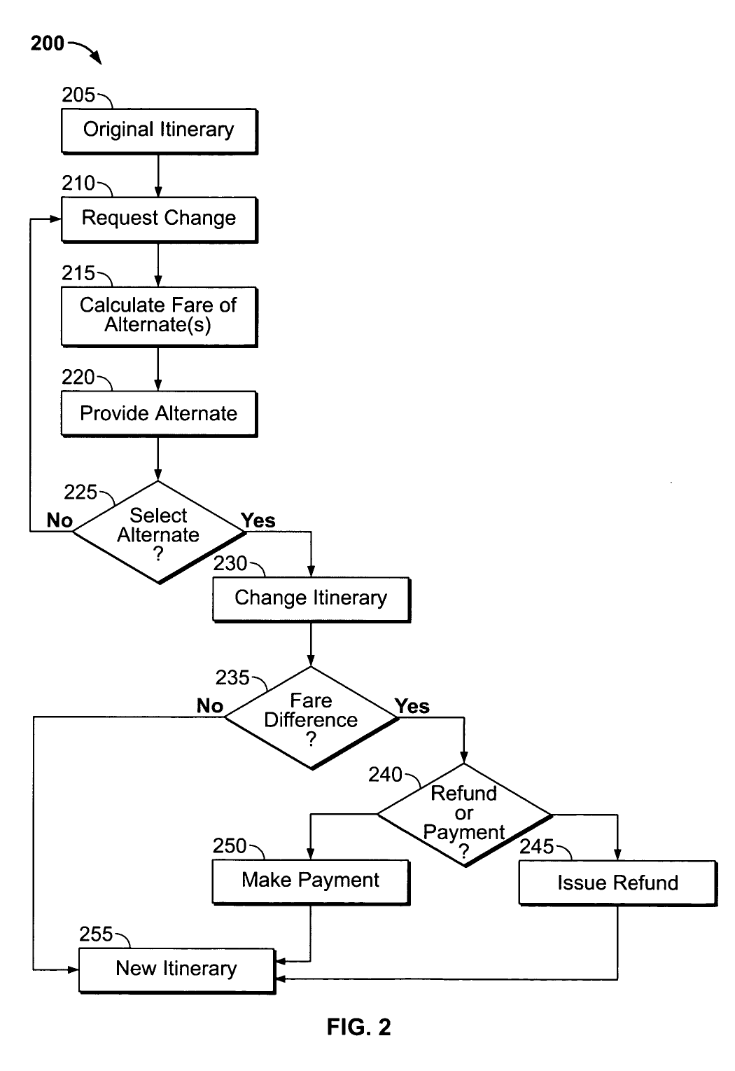

FIG. 2 is a flow diagram of a process 200 for changing a travel itinerary. The process 200 includes having an original itinerary in place (step 205). A customer desiring to change all or a portion of the itinerary may then make a request to change the itinerary (step 210). Upon making the request to change the itinerary at step 210, the customer may specify the criteria upon which the provider based the alternatives. Alternatively, the provider may automatically provide alternatives based on the segment, fare class, fare rules, or other suitable criteria without specific criteria from the customer.

Upon receiving the request for change at step 210, the provider may calculate the fare or fares of alternatives to the existing reservation (step 215). Also at step 215, the provider may determine that no suitable alternatives exist based on the customer's request for change. If no suitable alternatives exist, the customer may be directed to re-start the process of changing the travel itinerary. Alternatively, if no alternative segments exist that satisfy the customer's fare class, fare rules, travel dates, or original itinerary, the provider may select a group or range of alternative segments that satisfy less than all of the criteria entered by the customer in the request. Additionally, the provider may calculate the fare differences relative to the existing reservation at step 215. The fare differences may occur as the result of a difference in the total cost of the original itinerary and the travel itinerary that includes the alternative segment. After the fares are calculated, the alternatives may be provided to the customer (step 220). The alternatives at step 220 may be provided and/or displayed based on fare, time, location, vendor, fare difference or any other suitable criteria. After being provided the alternatives at step 220, the customer may decide whether to select one of the alternatives (step 225). If no alternative is selected at step 225, the customer may return to step 210 to request a change of a different portion of the existing itinerary, or the customer may request different criteria for displaying alternate itinerary options by returning to step 210 of the process 200.

If the customer selects one of the alternate itinerary options at step 225, the itinerary is changed (step 230). The provider may then determine whether a fare difference exists based on the fare calculated at step 215 by comparing the selected alternative with the original itinerary (step 235). The provider may be required to calculate the fare difference based on different fare rules provided for the purchased travel accommodations and the desired alternatives. In such a situation, calculating the fare and the fare difference may be based on fare rules associated with the original travel itinerary and on fare rules associated with the modified travel itinerary. If no fare difference exists, then the new itinerary is established (step 255). If a fare difference exists, then the customer is provided with either a refund amount or a payment amount (step 240). If a refund is due the customer because of the fare difference, the refund is provided to the customer (step 245), and the new itinerary is established (step 255). If a payment is due because of the fare difference, then the customer makes the required payment (step 250), and the new itinerary is established (step 255).

The described techniques and processes can be implemented in digital electronic circuitry, integrated circuitry, or in computer hardware, firmware, software, or in combinations thereof. Apparatus for carrying out the techniques can be implemented in a software product (e.g., a computer program product) tangibly embodied in a machine-readable storage device for execution by a programmable processor; and processing operations can be performed by a programmable processor executing a program of instructions to perform the described functions by operating on input data and generating output. The techniques can be implemented advantageously in one or more software programs that are executable on a programmable system including at least one programmable processor coupled to receive data and instructions from, and to transmit data and instructions to, a data storage system, at least one input device, and at least one output device. Each software program can be implemented in a high-level procedural or object-oriented programming language, or in assembly or machine language if desired; and in any case, the language can be a compiled and/or interpreted language. Actions described as being performed, for example, by the provider, can typically be performed automatically by software, digital circuitry, and the like.

Suitable processors include, by way of example, both general and special purpose microprocessors. Generally, a processor will receive instructions and data from a read-only memory, a random access memory and/or a machine-readable signal (e.g., a digital signal received through a network connection). Generally, a computer will include one or more mass storage devices for storing data files; such devices include magnetic disks, such as internal hard disks and removable disks, magneto-optical disks, and optical disks. Storage devices suitable for tangibly embodying software program instructions and data include all forms of non-volatile memory, including by way of example semiconductor memory devices, such as EPROM (electrically programmable read-only memory), EEPROM (electrically erasable programmable read-only memory), and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the techniques can be implemented on a computer system having a display device such as a monitor or LCD (liquid crystal display) screen for displaying information to the user and a keyboard and a pointing device such as a mouse or a trackball by which the user can provide input to the computer system or a system which enables input and presents information via voice, symbols, or other means such as a Braille input and output system. The computer system can be programmed to provide a graphical user interface through which computer programs interact with users. With new technologies such as voice input and output, it is not a requirement to have a visual display to implement the described techniques.

The invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

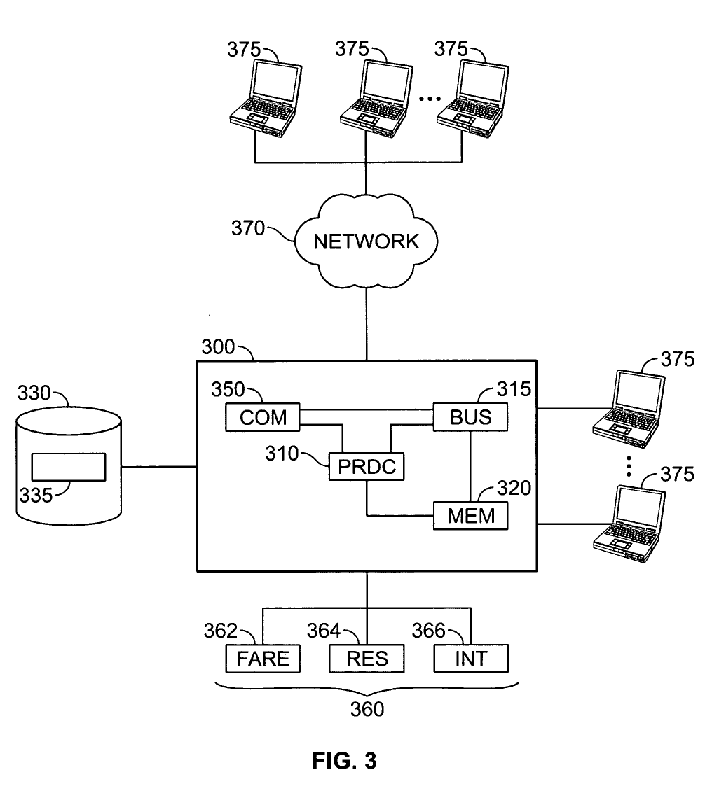

FIG. 3 is a block diagram illustrating an example data processing system 300 in which a system for changing a travel itinerary can be implemented. The data processing system 300 includes a central processor 310, which executes programs, performs data manipulations, and controls tasks in the system 300. The central processor 310 is coupled with a bus 315 that can include multiple buses, which may be parallel and/or serial buses.

The data processing system 300 includes a memory 320, which can be volatile and/or non-volatile memory, and is coupled with the communications bus 315. The system 300 can also include one or more cache memories. The data processing system 300 can include a storage device 330 for accessing a storage medium 335, which may be removable, read-only, or read/write media and may be magnetic-based, optical-based, semiconductor-based media, or a combination of these. The data processing system 300 can also include one or more peripheral devices, such as client devices 375, and one or more controllers and/or adapters for providing interface functions.

The system 300 can further include a communication interface 350, which allows software and data to be transferred between the system 300 and external devices, the network 370, or information sources. The communications may embody instructions for causing the system 300 to perform operations according to the logic modules 360. The system 300 represents a programmable machine, and can include various devices such as embedded controllers, Programmable Logic Devices (PLDs), Application Specific Integrated Circuits (ASICs), and the like. Machine instructions (also known as programs, software, software applications or code) can be stored in the system 300 and/or delivered to the system 300 over a communication interface. These instructions, when executed, enable the system 300 to perform the features and function described above. The instructions may also include logic modules 360 for executing specific operations based on imbedded instructions or external communications. These logic modules 360 represent application-specific controllers of the system 300 and can be implemented in a high-level procedural and/or object-oriented programming language, and/or in assembly/system language. Such languages can be compiled and/or interpreted languages.

As used herein, the term “machine-readable medium” refers to any computer program product, apparatus, and/or device used to provide system instructions and/or data to the system 300, including a machine-readable medium that receives system instructions as a machine-readable signal. Examples of a machine-readable medium include the storage medium 335, the memory 320, and/or PLDs, FPGAs, ASICs, and the like.

Logic modules 360 represent the functionality associated with changing a travel itinerary. These application-specific logic modules 360 may provide certain functionality related to fare calculation, reservation storage, retrieval, and manipulating, and/or interface with customers. Although the logic modules 360 illustrated in FIG. 3 are listed as three discrete logic modules 360, the specific functionality represented by the logic modules 360 may be implemented in any number of logic modules (e.g., by combining functionalities into a fewer number of modules, separating functionalities into a greater number of modules, distributing functionalities differently among the modules, and the like). In the implementation shown, the logic modules 360 include a fare module 362, a reservation module 364, and an interface module 366.

In the implementation illustrated by FIG. 3, the reservation module 364 may be called upon based on a request from a customer accessing one of the clients 375. The request may be enabled by functionality provided by the interface module 366. The interface module 366 may provide customers access to the system 300 by maintaining a connection between the system 300 and the network 370, such that clients 375 coupled to the network 370 may access the functionality of the system 300 to make changes to existing travel reservations. When a customer accesses the system 300 and indicates a desire to make changes to an existing travel reservation, reservation module 364 may direct the processor 310 to access the storage device 330 and the associated storage media 335 to retrieve an existing reservation for the customer. The request may be based on an existing PNR, a customer specific number, such as a “Rapid Rewards®”) number, or other customer specific information, such as the credit card information used to purchase the reservation retrieved.

After retrieving one or more reservations, the system 300 may display the information to the customer by transmitting details of the reservation to the customer through the network 370 at the direction of the interface module 366. The reservation module 364 may direct the system 300 to display some portion of the reservation information, or all of the information, depending on the specific request by the customer via one of the clients 375 and the network 370. For example, the customer may only wish that a portion of the reservation be displayed for possible changes. Alternatively, the customer may have already completed some portion of travel according to the reservation and only desire to change another portion of the reservation that has yet to be fulfilled. Alternatively, the existing reservation may be for travel that was scheduled in the past but was not completed by the customer. Thus, if the reservation was not used by the customer, changes may still be made according to various implementations.

Upon receiving a display of at least a portion of the original itinerary, either through a display associated with one of the clients 375 or other suitable method, the customer may request a change by transmitting the request using the client 375 through the network 370 to the system 300. Upon receiving the request, the processor 310 may implement functionality associated with the reservation module 364 to retrieve suitable alternate travel options for the customer. Alternate travel options may be stored in memory device 320, storage device 330 with associated storage media 335, or other suitable storage location. Additionally, fare module 362 may calculate the associated fares for any alternative travel arrangements selected by the reservation module 364 from the storage device 330 or other storage media (not shown) accessible by the system 300, such as an external database.

After the reservation module 364 and/or the fare module 362 have selected alternatives and calculated the associated fares and/or fare differences, respectively, the interface module 366 may communicate this information to the customer from the system 300 to the customer's client 375 via the network 370. The customer may select one or more of the travel alternatives provided by the system 300. Alternatively, the customer may reject the alternatives provided by the system 300 and change the criteria by which the system 300 selects travel alternatives.

If the customer selects one or more of the alternatives provided by the system 300, the customer may transmit the selection via the network 370 to the system 300. Upon receiving the selection, the system 300 may direct the fare module 362 to make any additional necessary calculations to determine the precise fare difference in the original itinerary and the new itinerary and transmit the difference to the customer. If the difference results in a refund to the customer, the fare module may automatically update the customer's itinerary, allowing the system to prompt the customer to accept or reject the new itinerary. In an alternative implementation, the system 300 may prompt the customer to determine how any refund is to be returned to the customer prior to updating the customer's itinerary.

If the fare difference results in an additional amount to be paid by the customer, the system 300 may transmit the proposed new itinerary to the customer and prompt the customer to either remit payment for the fare difference or reject the proposed itinerary. In a particular implementation, the customer may remit payment for the fare difference using any acceptable payment means to the provider. For example, the provider may require a credit card payment, application of any mileage bonuses, or any other suitable payment methods.

After the customer has selected a new itinerary, the fare module 364 may direct the processor 310 to update the passenger information by accessing the storage media 335 of the storage device 330 to update the new reservation. In one implementation, the system 300 maintains the original reservation until the reservation module 364 updates the customer's original itinerary with the new itinerary. According to this implementation, the old itinerary is not relinquished until the new reservation has been updated by the system 300, and any associated refunds or additional payments have been processed by the system 300.

If the customer rejects the alternatives provided by the system 300, the customer may change the criteria for the request by transmitting new criteria to the system 300. Alternatively, the customer may reject the alternatives provided by the system 300 and retain the original itinerary and associated reservation.

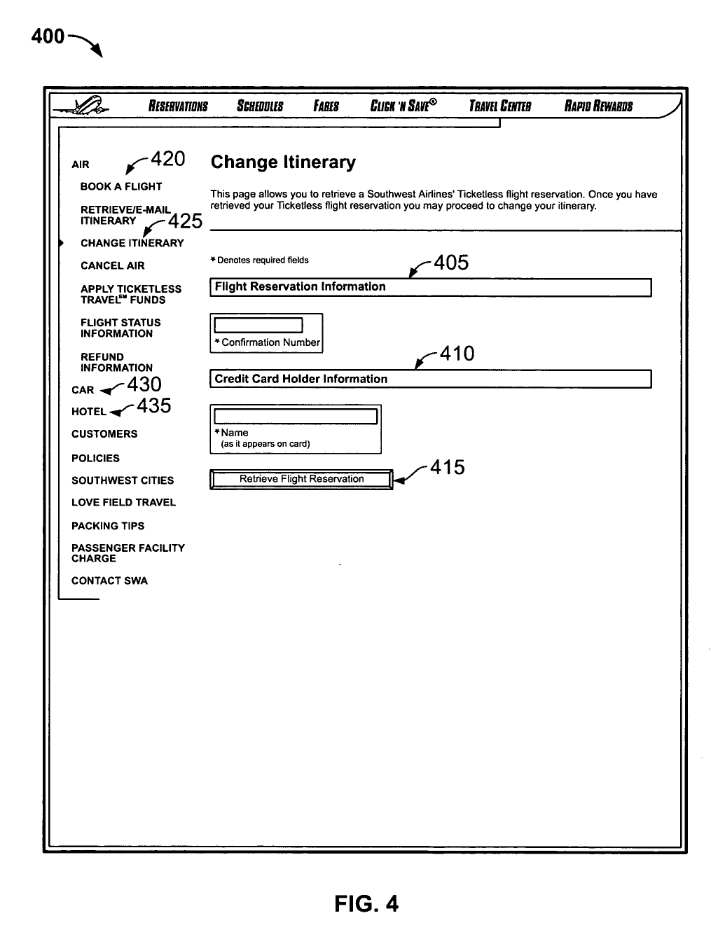

FIG. 4 depicts an illustrative example of a portion of a user interface 400 for changing a travel itinerary. The user interface 400 includes a reservation field 405 and a cardholder information field 410. Additionally, a “retrieve flight reservation”, “select”, or other button 415 may be included that allows a user to transmit information entered in one of the fields of the user interface 400 to the provider. The portion of a graphic user interface 400 shown is an example of a Web page that may be used to change air travel, as noted by the menu 420 listed on the left side of the interface 400. Specifically, the change itinerary button 425 may be depressed to display itinerary information on the graphic user interface 400. Alternatively, a user may click on “car” 430 or “hotel” 435 to bring up a “change itinerary” user interface for a rental car or hotel reservation, respectively, which may include similar features as the features relative to air travel in the user interface 400 illustrated by FIG. 4.

In operation, a user desiring to change an existing travel itinerary may access the portion of graphic user interface 400 by selecting and navigating to the appropriate interface, which may be performed from a Web browser on a personal computer, touchscreen browser at an airport or transportation terminal, Internet kiosk, or other suitable access point. Upon reaching the portion of the graphic user interface 400 as shown, a user may retrieve specific reservation information by entering a confirmation number or PNR in the reservation information field 405. Alternatively, a user may retrieve a specific travel itinerary or reservation by entering credit card information in the credit card information field 410. Alternatively, other methods may be used to retrieve itinerary information, such as birth date, password, or other suitable personal or itinerary specific information. Once the user has entered the required itinerary retrieval information, such as in the reservation information field 405 or the credit card holder information field 410, the user may click on the retrieve flight reservation button 415 in order to submit the data to the provider so the provider may retrieve the associated itinerary.

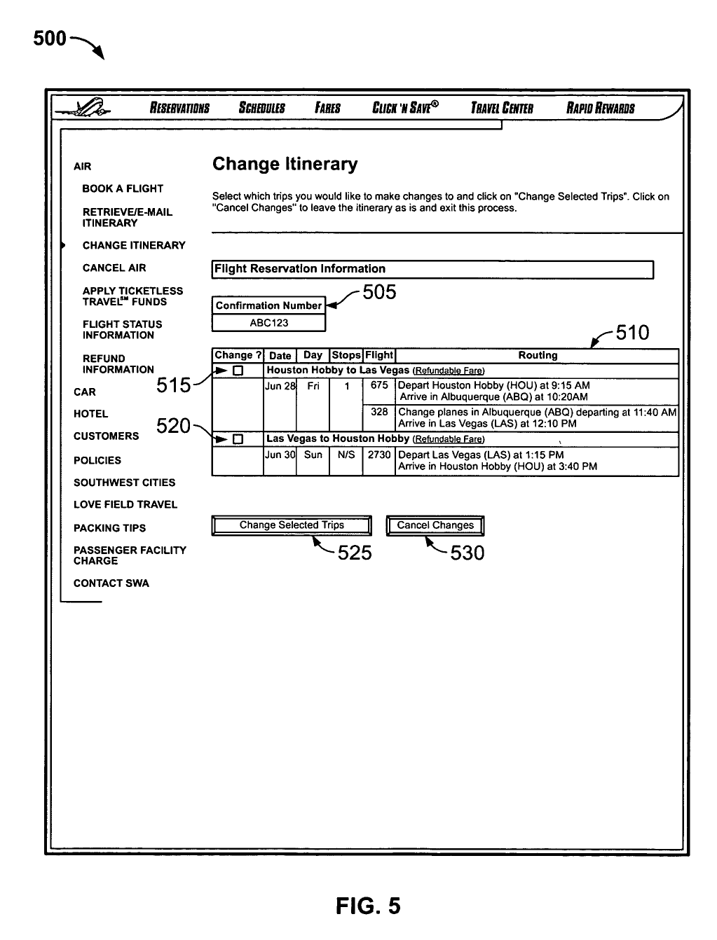

FIG. 5 illustrates a portion of a user interface 500 that is illustrative of a flight itinerary that has been retrieved by following the procedures and entering information required by the user interface 400 illustrated in FIG. 4. The user interface 500 includes a display of the confirmation number 505, as well as the itinerary 510 associated with the confirmation number 505. As shown, the itinerary 510 includes a first segment 515 and a second segment 520. However, multiple segments or only a single segment may be displayed as itinerary 510. Change boxes may be associated with each segment of itinerary 510. The change boxes may allow a user in the implementation shown to select an identified segment from the original itinerary 510 to be changed in the itinerary change process. The user interface 500 enables a user to select which segment the user desires to alter, or alternatively, allows a user to change both segments of the retrieved itinerary 510. After selecting one or more of the change boxes associated with a segment of itinerary 510, a user may click on the change trip button 525 to continue the itinerary change process. Upon receiving a selection of the change trip button 525, the provider may present the user with segment alternatives. Alternatively, the user may click the cancel button 530 to cease the itinerary change process.

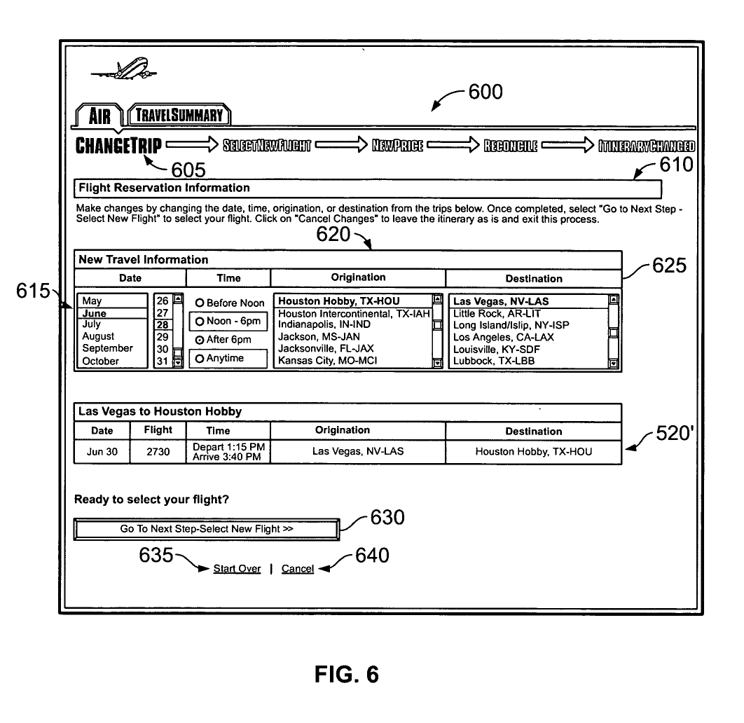

FIG. 6 illustrates a portion of a user interface 600 which may be used to present the user with alternatives to a selected segment or segments from the user interface 500 from FIG. 5. For example, if a user selects one of the segments for change, the provider may display a Web page similar to the user interface 600, which allows the user to change the selected leg after viewing the alternative segments selected by the provider. The user interface 600 may display a process menu 605 that displays the phase of itinerary change that corresponds to the user's progression through the itinerary change process. Additionally, an instruction menu 610 may be provided to further provide assistance to a user attempting to change an itinerary.

In the example provided by user interface 600, a user has selected to change one, but not both, of the segments of travel presented by user interface 500 in FIG. 5. Accordingly, user interface 600 displays the unselected segment 520′ in addition to drop down menus for a date 615, an origination 620, and a destination 625 associated with the segment to be changed. In the implementation shown, the alternative segments are chosen based on specific criteria entered by the user. However, in various implementations, the provider may allow a user to select an alternative segment based on more general criteria. Additionally, a “continue,” “next step,” or other suitably named button 630 may be included so that when a user has completed selecting the desired changes to a segment of the itinerary, the user may click on the button 630 to continue through the itinerary change process. Alternatively, a user may click a “new” or “start over” button 635 or a “cancel” button 640 to cease the current itinerary change process and either begin again by clicking the “start over” button 635 or cancel the itinerary change all together by clicking the cancel button 640.

The user interface 600 includes a scrollable menu 615 for the user's selection of month and day. Additionally, a preferred time range may be provided such that the user may select a period of time within a day at which the user desires to begin or complete a segment of travel to be changed. Alternatively, a scrollable menu may be included (not shown) that allows a user to pick a specific hour or hour range for the segment to be changed. Additionally, the origination menu 620 may be a scrollable menu, which allows the user to pick an origination location, such as an airport, city, or other transportation origination location. Destination menu 625 may be a scrollable menu, which allows the user to select a destination, city, airport, or other appropriate location based on the mode of travel involved. Other user interface components, such as data entry fields, can be used instead of scrollable menus for one or more of the travel parameters. After the user has fulfilled the requirements of the date 615, origination 620 and destination 625 menus, the user may click on the go to next step button 630 or, as stated above, re-start the process by clicking the start over button 635, or cancel the process by clicking the cancel button 640.

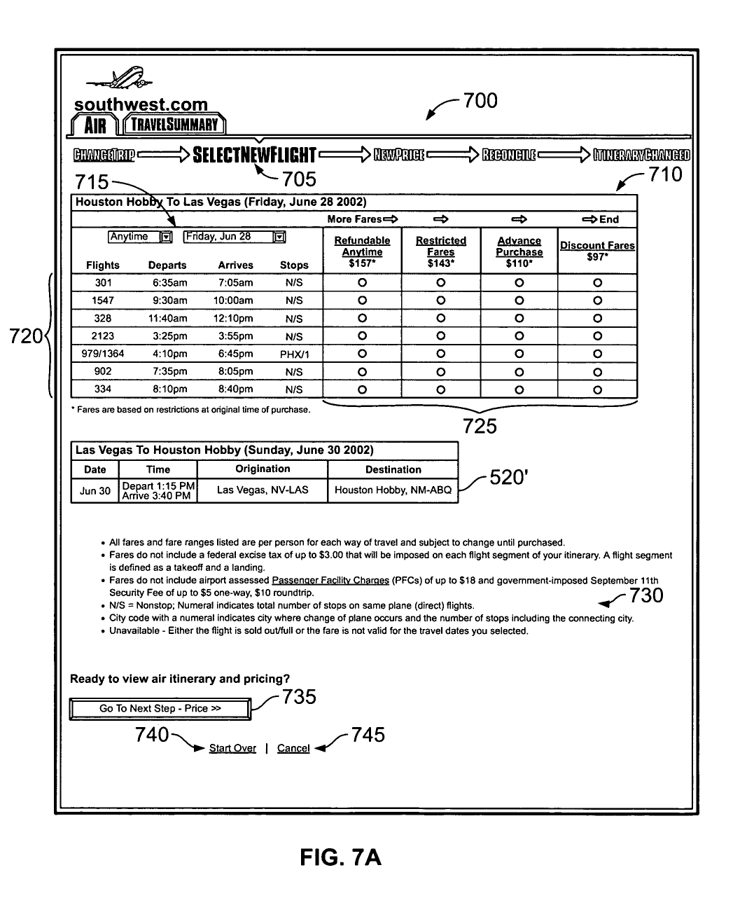

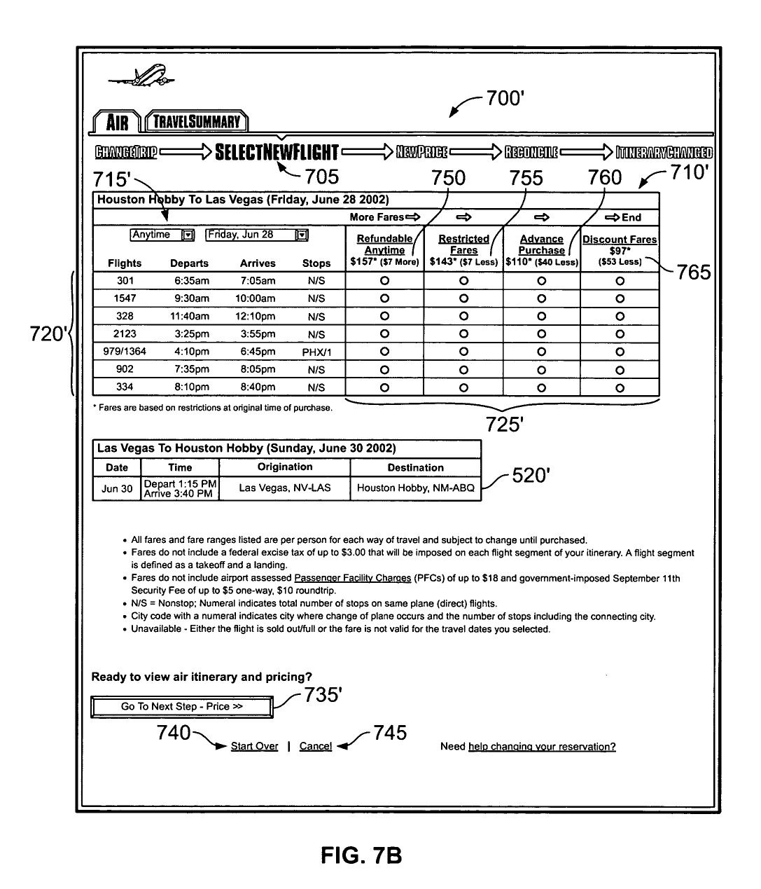

FIG. 7A illustrates a portion of a graphic user interface 700 in which prospective flight segments are displayed to a user based on the criteria specified at user interface 600 of FIG. 6. User interface 700 includes a navigation menu 705 in which a select new flight or similar progressive icon is highlighted to inform the user of the current progression through the itinerary change process. Additionally, alternative flight segments 710 are displayed so that a user may view the alternatives selected by the provider based on the criteria entered by the user at the user interface 600 of FIG. 6. Segment alternative 710 includes the user's desired date input 715 as entered on user interface 600 of FIG. 6. Additionally, alternative segment list 720 displays the flight segments 710 according to the time at which they depart and arrive from the origination and destination, respectively. Additionally, the segment list 720 may display the number of stops for air travel in which a flight may have to stop at an intermediate airport or facility between the origination and destination.

In addition to the flight list, a fare class list 725 may be included which shows the amount of the available fares calculated for each segment displayed by the flight segment list 720. Also, the unchanged segment 520′ may be displayed on the user interface 700 to assist the user in making the alternative segment reservation. Additionally, fare rules associated with the various fare classes presented in the fare class list 725 and/or other descriptive information may be displayed at a notes section 730 on the user interface 700. Additionally, a next button 735 may be included which allows a user, after making a selection of an alternative segment, to progress to the next stage of the itinerary change process. Alternatively, a user may elect to start over by clicking the start over button 740, or the user may elect to cancel the itinerary change by clicking the “cancel” button 745.

Upon viewing the user interface 700, a user may be able to compare the flight segments 710 from the segment list 720 and a desired fare class from the fare list 725. Different fares associated with the various alternative segments 720 may be provided that allow for different options available to the user for the alternative segments based on the fare rules associated with a given fare class. For example, a user may be able to compare a discount fare, an advanced purchase fare, a restricted fare, a fully refundable fare, or another fare class, if presented by the provider. Also, the associated cost of each fare may be calculated and included with the alternative segments 710 to assist the user in making the itinerary change.

Upon viewing the desirable alternatives, a user may select one of the alternative segments based on one of the provided fare classes by clicking on the fare box associated with the appropriate alternative segment 720. Subsequently, the user may click the next button 735 to proceed to the next stage of itinerary change.

FIG. 7B illustrates an alternative user interface 700′ in which the fare class list 725′ include a fare difference calculated based on the difference in cost of the segment to be changed from the original itinerary and the various fare classes presented that are associated with the alternative segments 710′. Accordingly, alternative segments 710′ may includes a date selection 715′ and a segment alternative list 720′ with associated fare classes 725′. Additionally, each of the available fares displayed in the fare class list 725′ that correspond to the segment alternative list 720′ include an associated fare difference for each fare with respect to the segment to be changed from the original itinerary. In the user interface 700′ shown, “refundable any time” fare segments are displayed with the calculation of the difference between the refundable any time fare and the fare of the original itinerary segment as a refundable fare difference 750. Additionally, the “restricted fare” segments are displayed as a restricted fare difference 755, as well as similarly calculated advance purchase difference 760 and the discount fare difference 765. The implementation shown by user interface 700′ allows a user to view on the screen the difference between the original itinerary segment fare and the alternative segment fare as calculated by the provider prior to the user selecting one of the alternative fares 725′.

In an alternate implementation, various fare classes may not be available to a user. For example, if a fare class's rules require a specified time period for advance purchase, and the user fails to attempt a change prior to the specified period, the provider may make a determination that the fare class and associated fare are not available for purchase by the user. Accordingly, the unavailability may be displayed to the user (not explicitly shown). Alternatively, the provider may choose not to display the fare class of an unavailable fare to the user, in which case the provider only displays fare classes available for purchase at the time the user accesses the system.

After the user selects an alternative fare 725′, the user may click the next button 735′ to continue in the itinerary change process. After the user selects a segment to replace the segment of the original itinerary to be changed, the user may be directed to pay an additional amount if the new itinerary segment is more expensive. Alternatively, if the selected replacement segment is less expensive than the original segment, the user may elect to have the excess amount refunded or applied to future reservations. After the new segment is reserved, provider may release the original, now-replaced segment.

A number of implementations have been described. Nevertheless, it will be understood that various modifications may be made. For example, throughout any of the implementations described above, the specific functionality of any of the logic modules 360 may be performed by less or more than the logic module 360 specifically listed. For example, the fare module 362 and the reservation module 364 may be combined into a single module to provide the functionality separately provided by the modules illustrated in FIG. 3. Alternatively, all of the logic modules 360 may be combined into a single module to provide the functionality described. Accordingly, other implementations are within the scope of the following claims.

1. A method for changing a travel itinerary, the method comprising:
receiving a request to make a change to a first travel itinerary, wherein the first travel itinerary includes at least one segment;
displaying an identification of at least one alternative segment in response to the request to make a change, if the at least one alternative segment is available;
receiving a user selection of an alternative segment from the displayed identification of at least one alternative segment;
modifying the first travel itinerary to include a reservation for the selected alternative segment; and
releasing a segment to be replaced in the first travel itinerary after modifying the first travel itinerary to include the reservation, wherein the modified first travel itinerary, after releasing the segment to be replaced, comprises a second travel itinerary.

2. The method of claim 1 wherein the at least one segment is subject to a fare rule, the fare rule at least partially defining a fare class to which the at least one segment belongs.

3. The method of claim 2, further comprising determining whether the at least one alternative segment is compatible with a segment in the first travel itinerary, the compatibility being determined by at least one from the group consisting of seat availability, fare rule, fare class, and combinability.

4. The method of claim 1, further comprising:
determining whether the at least one alternative segment will change a total cost of the first travel itinerary; and
calculating a fare difference between the first reservation and the second travel itinerary.

5. The method of claim 4, wherein the determination of whether the at least one alternative segment will change the total cost of the reservation is based on at least one from the group of seat availability, fare class, fare rule, and combinability.

6. The method of claim 1 further comprising receiving an identification of the segment to be replaced in the first travel itinerary.

7. The method of claim 6 further comprising:
receiving an identification of the first travel itinerary; and
displaying the first travel itinerary, wherein the identification of the segment to be replaced is selected by a user from the displayed first travel itinerary.

8. The method of claim 7 further comprising verifying a user identity prior to modifying the first travel itinerary.

9. The method of claim 1 wherein displaying the identification of at least one alternative segment comprises displaying a list of alternative segments.

10. The method of claim 1 further comprising receiving a user selection of at least one parameter selected from the group consisting of an origination, a destination, a travel date, and a travel time, wherein the displayed list of alternative segments comprises segments that match a criterion defined by the at least one parameter.

11. The method of claim 1 wherein the first travel itinerary comprises a round-trip itinerary, the segment to be replaced comprises a return segment of the round-trip itinerary, and the request to make a change to the first travel itinerary is received after a completion of an originating segment of the round-trip itinerary.

12. The method of claim 1 further comprising calculating a fare associated with the selected alternative segment prior to modifying the first travel itinerary.

13. The method of claim 12 further comprising:
calculating fares associated with each of the at least one alternative segment prior to modifying the first travel itinerary; and
displaying, for each alternative segment, at least one of the calculated fares and a difference between the calculated fare and a first fare.

14. The method of claim 12 further comprising:
calculating a difference between the calculated fare and a first fare; and
displaying the calculated difference in association with the displayed identification of the selected alternative segment prior to receiving the user selection of the alternative segment.

15. The method of claim 14 further comprising displaying a plurality of fare classes for the selected alternative segment, with each fare class including an indication of a difference between a calculated fare for that fare class and the first fare, wherein each of the fare classes is defined by at least one fare rule.

16. The method of claim 15 further comprising:
determining an availability for each of the plurality of fare classes; and
displaying an indication of unavailability for fare classes that are unavailable.

17. The method of claim 16 wherein determining an availability comprises at least one of determining if fares for the selected fare classes are available for purchase and determining if each fare class for the selected alternative segment satisfies limitations on the first travel itinerary.

18. A method for changing a travel itinerary, the method comprising:
receiving a request to make a change to a first travel itinerary, wherein the first travel itinerary includes at least one segment;
calculating, in response to the request to make a change, at least one of a fare and a fare difference for each of at least one alternative segment;
displaying an identification of the at least one alternative segment, wherein the displayed identification further includes an indication of at least one of the fare and the fare difference for each of the at least one alternative segment; and
receiving a user selection of a particular alternative segment from the displayed identification of the at least one alternative segment.

19. The method of claim 18 further comprising:
modifying the first travel itinerary to include a reservation for the selected alternative segment; and
releasing a segment to be replaced in the first travel itinerary.

20. The method of claim 19 further comprising at least one of:
receiving payment of an amount due corresponding to the fare difference; and
ing a credit corresponding to the fare difference.

21. The method of claim 19 wherein calculating at least one of the fare and the fare difference is based on at least one first fare rule associated with the first travel itinerary and on at least one second fare rule associated with the modified first travel itinerary.

22. The method of claim 19 wherein releasing a segment to be replaced is performed after modifying the first travel itinerary to include the reservation, and wherein the modified first travel itinerary comprises a second travel itinerary.

23. A computer program product, tangibly stored on a computer-readable medium, for changing a travel itinerary, comprising instructions operable to cause a programmable processor to:
receive a request to make a change to a first travel itinerary, wherein the first travel itinerary includes at least one segment;
display an identification of at least one alternative segment in response to the request to make a change;
receive a user selection of an alternative segment from the displayed identification of at least one alternative segment;
modify the first travel itinerary to include a reservation for the selected alternative segment; and
release a segment to be replaced in the first travel itinerary after modifying the first travel itinerary to include the reservation, wherein the modified travel itinerary, after releasing the segment to be replaced, comprises a second travel itinerary.

24. The product of claim 23, the instructions further operable tocause a programmable processor to:
determine if the at least one segment is subject to a first fare rule; and
determine if the first fare rule permits modification of the first travel itinerary by changing the first itinerary to include the at least one alternative segment.

25. The product of claim 24, the instructions further operable tocause a programmable processor to calculate a fare difference between the first travel itinerary and the second travel itinerary.

26. The product of claim 25, the instructions further operable tocause a programmable processor to display the fare difference before receiving the user selection of an alternative segment from the displayed identification of at least one alternative segment.

27. The product of claim 23, the instructions further operable tocause a programmable processor to:
calculate, in response to the request to make a change, at least one of a fare and a fare difference for each of at least one alternative segment;
display an identification of the at least one alternative segment, wherein the displayed identification further includes an indication of at least one of the fare and the fare difference for each of the at least one alternative segment.

28. The product of claim 27, the instructions further operable tocause a programmable processor to:
receive payment of an amount due corresponding to the fare difference; and
store a credit corresponding to the fare difference.

29. The product of claim 28, wherein calculating at least one of the fare and the fare difference is based on fare rules associated with the first travel itinerary and on fare rules associated with the second travel itinerary.

30. The product of claim 29, wherein releasing a segment to be replaced is performed after modifying the first travel itinerary to include the alternative segment.

31. The product of claim 23, the instructions further operable tocause a programmable processor to:
determine that no alternative segment is available; and
display a message that indicates that no alternative segment is available.

32. An article comprising a machine-readable medium storing one or more logic modules for causing one or more processors to perform operations, the one or more logic modules comprising:
a reservation module operable to cause one or more processors to perform functions including:
receive a request to make a change to a first travel itinerary, wherein the first travel itinerary includes at least one segment;
display an identification of at least one alternative segment in response to the request to make a change, wherein the identification of the at least one alternative segment includes a fare difference between the at least one alternative segment and the first travel itinerary;
receive a user selection of an alternative segment from the displayed identification of at least one alternative segment;
modify the first travel itinerary to include a reservation for the selected alternative segment; and
release a segment to be replaced in the first travel itinerary after modifying the travel itinerary to include the reservation, wherein the modified travel itinerary, after releasing the segment to be replaced, comprises a second travel itinerary.

33. The article of claim 32, further comprising:
an interface module operable to provide an interface between a computer system and a customer.

34. The article of claim 32, further comprising:
a fare module operable to perform functions including:
calculating, in response to the request to make a change, at least one of a fare and a fare difference for each of at least one alternative segment; and
displaying an identification of the at least one alternative segment, wherein the displayed identification further includes an indication of at least one of the fare and the fare difference for each of the at least one alternative segment.

35. The article of claim 32, wherein releasing a segment to be replaced is performed after modifying the first travel itinerary to include the reservation.
